(19) United States
(12) Patent Application Publication
(10) Pub. No.: US 2017/0034586 A1
(43) Pub. Date: Feb. 2, 2017

(54) SYSTEM FOR CONTENT MATCHING AND TRIGGERING FOR REALITY-VIRTUALITY CONTINUUM-BASED ENVIRONMENT AND METHODS THEREOF

(71) Applicant: WAKINGAPP LTD., ROSH HAAYIN (IL)

(72) Inventors: Alon MELCHNER, ROSH HAAYIN (IL); Adiel GUR, PETCH-TIKVA (IL)

(73) Assignee: WAKINGAPP LTD., ROSH HAAYIN (IL)

(21) Appl. No.: 15/303,013

(22) PCT Filed: Jan. 10, 2016
(86) PCT No.: PCT/IL16/50026

§ 371 Date: Oct. 10, 2016

Related U.S. Application Data
(60) Provisional application No. 61/103,615, filed on Oct. 8, 2008.

(51) Int. Cl. H04N 21/482; H04N 21/258; H04N 21/45; H04N 21/431

(52) U.S. Cl. CPC H04N 21/4826; H04N 21/4312; H04N 21/25883; H04N 21/4532

(57) ABSTRACT

A system and methods for matching and triggering content for reality-virtuality continuum-based environment by using a mobile internet device. In general, in one aspect the invention is system for a matching and triggering content for reality-virtuality continuum-based environment comprising steps of acquiring a content at a device based on one or more mobile device sensors; obtaining metadata corresponding to said content matched with the content from a server; suggesting content from said content database corresponding to said content for user's preferable choice; and augmenting a displayed content on said device with said information based on user's acquiring a content at a device based on one or preferable choice.

### FIELD OF THE INVENTION

The present invention relates to methods and system for matching and triggering content for reality-virtuality continuum-based environment and methods thereof by using a mobile internet device.

### BACKGROUND OF THE INVENTION

Many of the latest mobile internet devices (MIDs) feature consumer-grade cameras, wide area network (WAN) and wireless local area network (WLAN) connectivity, location sensors (e.g., global positioning system (GPS) receivers), and various orientation and motion sensors. These features can be used to implement a mobile system for content matching and triggering for reality-virtuality continuum-based environment on the mobile internet device. A mobile augmented reality system comprises a system that can overlay information on a live content stream. The information can include identifying distances to objects in the live content stream, provide or link to information relating to a location of a device implementing mobile augmented reality, and other information. This information can be overlaid on a display of a live content stream from the camera on the mobile internet device. This information can also be updated as the location of the mobile internet device changes. In the past few years, various methods have been suggested to present augmented content to users through mobile internet devices. More recently, several mobile augmented reality applications for mobile internet devices have been announced.

Content search is a concept where by using a camera (e.g. in a mobile phone) or using one or more of mobile device sensors (GPS, user recognition, etc.) a visualisation or a location of a physical object is captured and recognized by computer algorithms and useful information is presented back to the user about the physical object. Said that, content search can be also enabled by user input keywords and not just the device sensors for better results, as an additional option to search for specific content packs without relying only on sensors.

The aim of content search is primarily to identify the physical object or the user's location and thereby present the user with some information. This information is called metadata, and it could be of various formats e.g. video files, audio files, Web pages, images animation files, applications suggestions, etc.

Most current visual search systems adopt the feature based image matching approach [see e.g. G. Takacs et al “outdoors augmented reality on mobile phone using loxel-based visual feature organization” in ACM International Conference on Multimedia Information Retrieval, Vancouver, Canada, October 2008]. By representing images or objects using sets of local features, recognition can be achieved by matching features between the query image and candidate database image. Fast large-scale image matching is enabled using a Vocabulary Tree (VT). Features are extracted from the database of images and a hierarchical k-means clustering algorithm is applied to all of these features to generate the VT. Descriptors of the query image are also classified through the VT and a histogram of the node visits on the tree nodes is generated. Candidate content is then sorted according to the similarity of the candidate database image histogram and a query image histogram Geometric Verification (GV) is applied after feature matching [see S. S. Tsai, D. Chen, J Singh, and B. Girod, “Rate-efficient, real-timer CD cover recognition on a camera-phone” in ACM international Conference on Multimedia, Vancouver, Canada, October 2008] to eliminate false feature matches. In this process, features of the query object are matched with features of the database objects using nearest descriptor or the ratio test. Then, a geometric transformation of the location of the features in the query object and the locations of the features in the database object is estimated using RANdom SAmple Consensus (RANSAC) algorithm [see M. Fiscler and R. Bolles, “Random sample consensus: a paragigm for model fitting with applications to image analysis and automated cryptography” Communications of ACM, vol. 24, no. 1, pp. 381-395, 1981]. Image capture and feature manipulations are proposed to be performed in the mobile terminal, while VT and GV are performed on a server in the Internet.

Augmented reality (AR) is an upcoming paradigm of presenting metadata of physical objects as an overlay over the image or video of a physical object in real time. Special applications called augmented reality browsers (AR browsers) are used in terminals e.g. mobile phones and these are gaining popularity. The AR browsers perform two main functions; visual search initiation and overlay display of metadata on the end user terminal display. The AR server incorporates elements of visual search and of an overlay object server. The visual search component performs the matching of an image to the dataset and the file server performs the function of sending the corresponding overlay data to the AR browser for displaying to the end user. It should be noted that the overlay data could range from simple text to a complex webpage containing text, audio and video components. Also it may be possible for the end user to further interact with the overlay data displayed e.g. start/stop video, scroll text, enlarge image etc. Overlay data is also called metadata of the physical object and this is the term that will be used in this document. Businesses could take advantage of AR in a multitude of ways, such as personalized shopping: walking around stores made relevant with the ability to opt in personalization and targeting. Here information of potential customers can be delivered by scanning stores, streets or shelves for discounted or personally relevant products; location layers: blended guides to new places, tourism, enhanced traveling or themed space; blended branding: the equivalent of virtual poster ads.

In all case there is an entity which uses Augmented Reality AR to deliver a service or enhanced experience to an end user. The end user is interacting with a physical object of the entity.

Augmented or mixed reality is a way of superimposing or overlaying computer generated information onto a physical or real-world environment. Augmented reality (AR) provides a view of a physical, real-world environment whose elements are augmented (or supplemented) by computer-generated sensory input such as sound, text, graphics, or video. Augmented reality is useful in various applications including construction, repair, maintenance, education, navigation, design, military, medical, or entertainment, for example. Virtual reality (VR) provides an immersive, interactive three-dimensional computer-generated environment in which interaction takes place over multiple sensory channels and includes tactile and positioning feedback. A review of existing matching immersive reality-virtuality continuum-based environment platforms reveals a need for an improved triggering system which incorporates mobile device sensors to deliver immersive reality-virtuality continuum-based content for users to use with their mobile internet devices.

In light of the above, there is a long term unmet need to provide such system for matching and triggering content for reality-virtuality continuum-based environment.

### SUMMARY OF THE INVENTION

It is hence one object of this invention to disclose a system and methods for matching and triggering content for reality-virtuality continuum-based environment by using a mobile internet device. In general, in one aspect the invention is system for a matching and triggering content for reality-virtuality continuum-based environment comprising steps of acquiring a content at a device based on one or more mobile device sensors; obtaining metadata corresponding to said content matched with the content from a server; suggesting content from said content database corresponding to said content for user's preferable choice; and augmenting a displayed content on said device with said information based on user's preferable choice.

In general, another object of this invention is to disclose a system for matching and triggering content for reality-virtuality continuum-based environment tool and method that comprises steps of extracting configurable features from searchable content; sending features corresponding to said searchable content to a server; and obtaining matching information includes receiving information from said server. Mobile device sensors can include one or more location-based sensors, visual content sensors, touch-based sensors, movement-based sensors, scent-based sensors and others, while displayed content includes overlaying an object on a live content view on a mobile device display.

Another object of this invention is to disclose a ranking suggestion for reality-virtuality continuum-based environment to the at least one content wherein when one of the at least one ranking suggestion is selected, information corresponding to the selected at least one ranking suggestion from a server is displayed. The ranking suggestion corresponds to configurable features of ranking content database, such as most popular content, most relevant content, most resembling content, location-based content, origin search-based content, nearby content, user's profile and activity behavior content, third-parties integration content, external link content, URL scheme content and any combination thereof.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 presents an example of a mobile internet device for communicating in the wireless communication system according to the present invention;

FIG. 2 presents an example of server for use in the wireless communication system according to the present invention;

FIG. 3 is a flow diagram illustrating a method for matching and triggering content for reality-virtuality continuum-based environment;

FIG. 4 presents a block diagram of an example implementation of a mobile augmented reality in the communications system.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The term “reality-virtuality continuum-based environment” refers in the present invention to augmented and/or virtual reality and/or any other “mixed reality” content (combination of real world and digital world including AR, VR, holograms, projections, smart glasses, 2D & 3D mixed reality, dynamic data and any other digital content that may appear inside mixed reality).

The term “developing”, as used in the present invention, refers to creating, designing, establishing, modifying, or adapting reality-virtuality continuum-based destination object to form a specific configuration or for some specific purpose, for example in a form of collective reality-virtuality continuum-based environment.

The term “user” refers to a person attempting to match content for reality-virtuality continuum-based environment by using a mobile internet device.

The term “content” refers to a metadata that can be acquired by a user using one or more sensors of a mobile internet device. It also refers to any metadata that is uploadable to the network server to serve as ranked content corresponding to searchable content, said ranked content can consist of: most popular content, most relevant content, most resembling content, location-based content, origin search-based content, nearby content, user's profile and activity behavior content, third-parties integration content, external link content, URL scheme content, chronologically sorted content (by upload date) as in who was the first one to upload the first of the similar targets (the original) and any combination thereof.

The term “database” refers hereinafter to any collection, set, assortment, cluster, selection and/or combination of transferred metadata and stored digitally.

The term “mobile device” interchangeably refers, but not limited to such as a mobile phone, laptop, tablet, cellular communicating device, digital camera (still and/or video), PDA, computer server, video camera, television, electronic visual dictionary, communication device, personal computer, internet device, and etc.

The term “sensor” interchangeably refers, but not limited to, a hardware or software component that can react or analyze mobile device activities, such as network activity, Wi-Fi activity, proximal routers activity, Bluetooth activity, RFID, proximal devices activity, gyroscope activity, accelerometer activity, compass activity, microphone activity, speaker activity, CPU activity, speaker activity, batter activity, data cable activity, device volume activity, power buttons usage activity, decoders activity, mobile device buttons activity, camera activity, screen GPU allocation activity, touch screen input activity, flashlight activity, LED notification activity, storage usage activity, memory usage activity, proximity detector activity, inter-process messaging activity, associated with said mobile device sensors activity and any combinations thereof. For example, a set of RFID chips which can represent lottery tickets that were embedded in a certain product-line will enable the system to trigger chip-stored content without going to the server to process search results or Bluetooth replacing GPS based coordinates, with indoor locations (such as shops within a mall that transmit data to 1-3 meters radius as a trigger to their content packs).

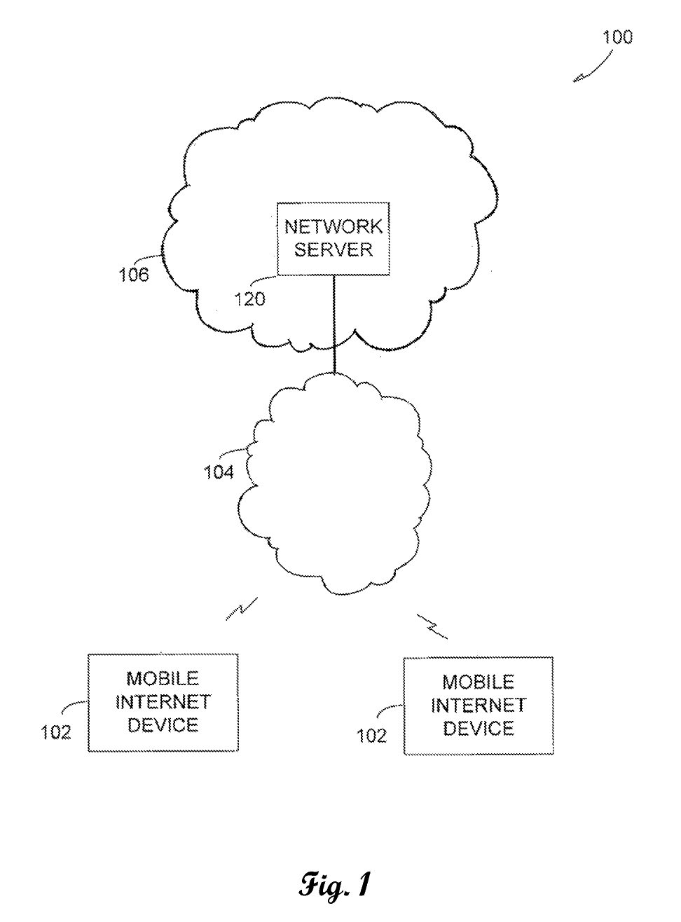

Reference is made to FIG. 1, presenting an example of a wireless communication system 100. The wireless communication system 100 can include a plurality of mobile internet devices 102 in wireless communication with an access network 104. The access network 104 forwards information between the mobile internet devices 102 and the internet 106. In the Internet 106 the information from the mobile internet devices 102 is sent to the network servers 120 in the internet 106.

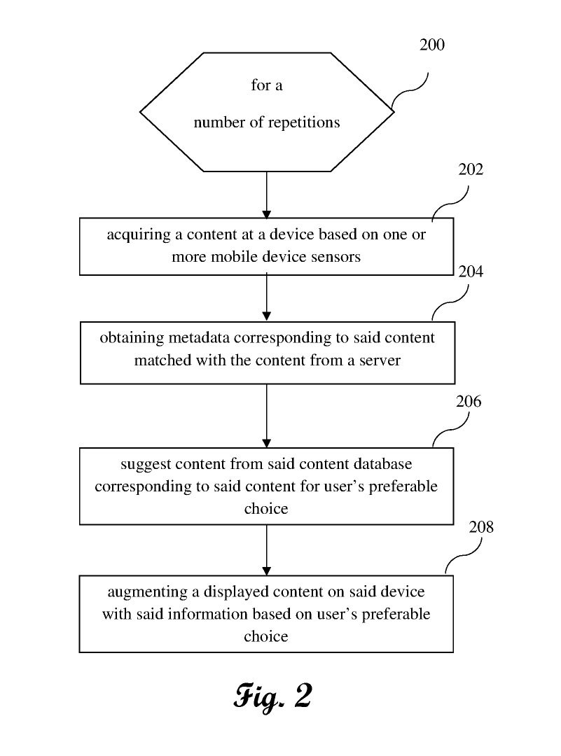

Reference is made to FIG. 2, presenting a flow diagram illustrating a method for matching and triggering content for reality-virtuality continuum-based environment, said methods comprising steps of for a number of repetitions 200 acquiring a content at a device based on one or more mobile device sensors 202 obtaining metadata corresponding to said content matched with the content from a server 204 suggest content from said content database corresponding to said content for user's preferable choice 206 and augmenting a displayed content on said device with said information based on user's preferable choice 208.

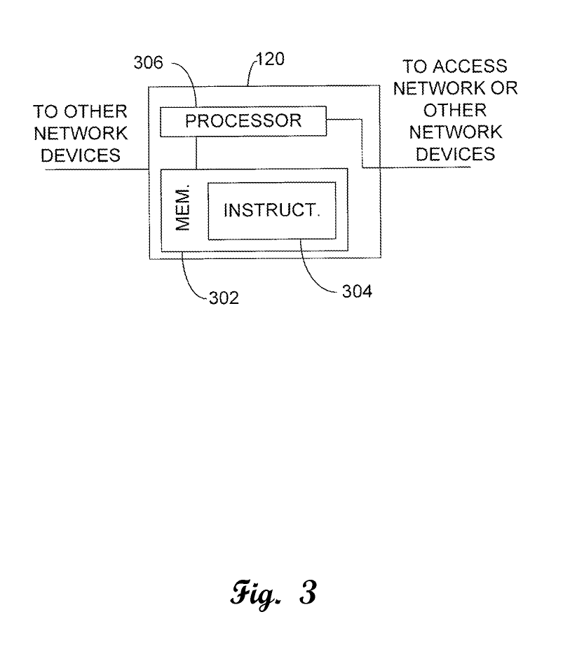

Reference is made to FIG. 3, presenting an example of a network server 120. The network server 120 can include a memory 302 for storage of instructions 304 for execution on processing circuitry 306. The instructions 304 can comprise software configured to cause the network server 120 to perform functions as described below.

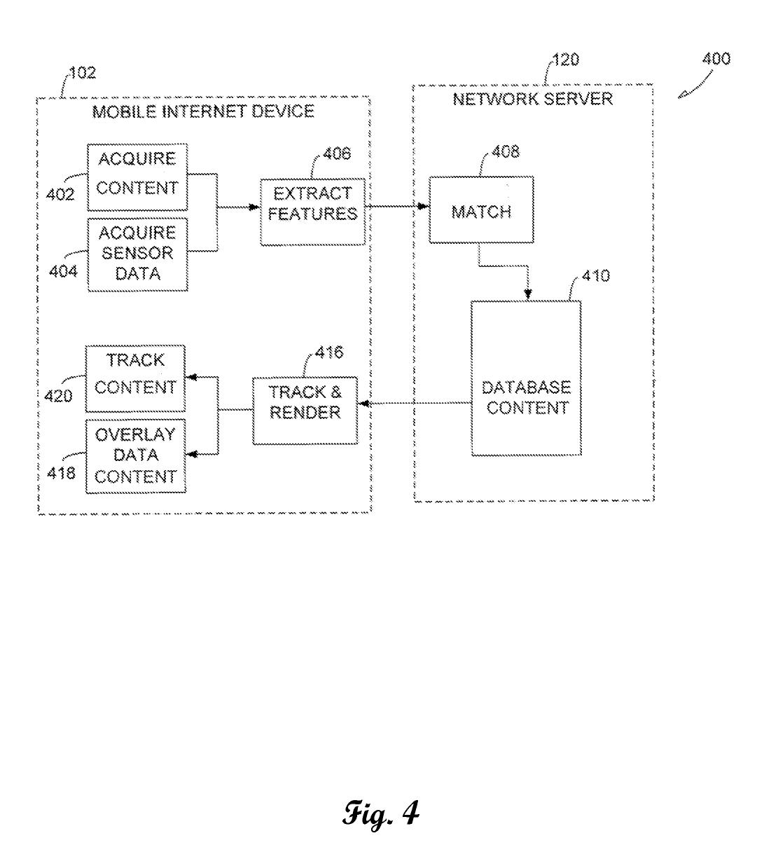

Reference is made to FIG. 4, presenting a block diagram 400 of an example implementation of a mobile augmented reality in the communications system 100 of FIG. 1. At 402, the mobile internet device 102 acquires a content with one or more mobile device sensors. At 404, the mobile internet device 102 acquires sensor data corresponding to the content with one or more sensors. At 406, features are extracted from the searchable content and the features are sent to the network server 120 for matching with other content. The features can be extracted using any suitable feature extraction algorithm. The extracted features and the acquired sensor data are then sent to the network processor 120. At 408, the features and the sensor data are used to identify content that match with the content acquired by the mobile internet device 102. When the network server 120 receives the features and the sensor data from the mobile internet device 102, the network server 120 can perform content matching to identify content from a content database 410 that match with the features from the content acquired by the mobile internet device 102. The content database 410 used by the network server 120 to match with the ranked content can be populated with present content on the network server 120 or content uploadable by users.

What is claimed is:

1. A method for a matching and triggering content for reality-virtuality continuum-based environment system comprising:
a. acquiring a content at a device based on one or more mobile device sensors;
b. obtaining metadata corresponding to said content matched with the content from a server;
c. suggesting content from said content database corresponding to said content for user's preferable choice; and
d. augmenting a displayed content on said device with said information based on user's preferable choice.

2. The method of claim 1, wherein mobile device sensors include one or more location-based sensors, visual content sensors, touch-based sensors, movement-based sensors, scent-based sensors, sound-based sensors, gesture-based sensors, and any combination thereof.

3. The method of claim 1, wherein augmenting a displayed content includes overlaying an object on a live content view on a mobile device display.

4. The method of claim 2, wherein the object includes a ranking suggestion to the at least one content wherein when one of the at least one ranking suggestion is selected, information corresponding to the selected at least one ranking suggestion from a server is displayed.

5. The method of claim 4, wherein a ranking suggestion corresponds to configurable features of ranking content database, consisting of: most popular content, most relevant content, most resembling content, location-based content, origin search-based content, nearby content, user's profile and activity behavior content, third-parties integration content, external link content, URL scheme content, chronologically sorted content and any combination thereof.

6. The method of claim 1, comprising:
a. extracting configurable features from searchable content;
b. sending features corresponding to said searchable content to a server;
c. obtaining ranking information includes receiving information from said server; and
d. wherein ranked information consisting of: most popular content, most relevant content, most resembling content, location-based content, origin search-based content, nearby content, user's profile and activity behavior content, third-parties integration content, external link content, URL scheme content, chronologically sorted content and any combination thereof.

7. The method of claim 6, wherein the method is performed by a mobile internet device and wherein said mobile internet device acquires said searchable content with an associated mobile device sensor.

8. The method of claim 1, wherein if only one unique match acquired, said user is not presented with results but said matching to unique result content is downloaded automatically.

9. A method for a matching and triggering content for reality-virtuality continuum-based environment system comprising:
a. receiving configurable features corresponding to a searchable content from a device;
b. identifying ranked content that matches with said searchable content from a device using said configurable features;
c. sending information corresponding to the at least one ranked content to said device.
d. suggesting content from said content database corresponding to said content for user's preferable choice said content consisting: most popular content, most relevant content, most resembling content, location-based content, origin search-based content, nearby content, user's profile and activity behavior content, third-parties integration content, external link content, URL scheme content, chronologically sorted content and any combination thereof.

10. The method of claim 9, comprising:
a. selecting a plurality of content from a database that have corresponding ranking information to said searchable content;
b. identifying includes comparing each of said plurality of ranked content to said searchable content.

11. The method of claim 9, comprising:
a. populating a content database for matching with searchable content received from said device by including content from users; and
b. associating a content from a user corresponding to said searchable content.

12. A server coupled to the internet comprising at least one processor configured to:
a. receive configurable features corresponding to a searchable content from a device;
b. receive matching information corresponding to said searchable content;
c. identify at least one searchable content that matches with the ranked content using said configurable features and said ranking information of most popular content, most relevant content, most resembling content, location-based content, origin search-based content, nearby content, user's profile and activity behavior content, third-parties integration content, external link content, URL scheme content, chronologically sorted content and any combination thereof; and
d. send information corresponding to said at least one ranked content to said device.

13. The server of claim 12, wherein the at least one processor is configured to:
a. select a plurality of content from a ranked content database that have corresponding ranking information to said searchable content;
b. identify the closest content from the plurality of ranked content as a matching with said searchable content;
c. suggest content from said content database corresponding to said content for user's preferable choice consisting of: most popular content, most relevant content, most resembling content, location-based content, origin search-based content, nearby content, user's profile and activity behavior content, third-parties integration content, external link content, URL scheme content, chronologically sorted content and any combination thereof.

14. The server of claim 12, wherein the at least one processor is configured to:
a. populate an content database for matching with searchable content received from said device by including content from users; and
b. populate a content from a user corresponding to said searchable content.

15. A computer-readable storage medium having stored therein a computer program loadable into a processor of a communication system, wherein said computer program comprises code adapted to perform a method for performing content search and augmented reality in a communication system comprising an Internet network attached to a mobile network, the method comprising:
a. receiving configurable features corresponding to a searchable content from a device;
b. receiving location coordinate information corresponding to said searchable content from a device;
c. identifing at least one searchable content that matches with the ranked content using said configurable features and said ranking information of most popular content, most relevant content, most resembling content, location-based content, origin search-based content, nearby content, user's profile and activity behavior content, third-parties integration content, external link content, URL scheme content, chronologically sorted content and any combination thereof;
d. sending information corresponding to the at least one ranked content to said device; and
e. suggesting content from said content database corresponding to said content for user's preferable choice.

16. The system of claim 15, wherein said system comprises code adapted to perform a method for performing content search and augmented reality in a communication system comprising an Internet network attached to a mobile network, the method comprising:
a. selecting a plurality of content from a database that have corresponding ranking information to said searchable content; and
b. wherein identifying includes comparing each of said plurality of ranked content to said searchable content.

17. The system of claim 15, wherein said system comprises code adapted to perform a method for performing content search and augmented reality in a communication system comprising an Internet network attached to a mobile network, the method comprising:
a. populating an content database for matching with searchable content received from said device by including content from users; and
b. associating a content from a user corresponding to said searchable content.

18. The system of claim 15, wherein said system comprises code adapted to perform a method for performing content search and augmented reality in a communication system comprising an Internet network attached to a mobile network, the method comprising:
a. receive configurable features corresponding to a searchable content from a device;
b. receive matching information corresponding to said searchable content;
c. identify at least one searchable content that matches with the ranked content using said configurable features and said ranking information of said users; and
d. send information corresponding to said at least one ranked content to said device.

19. The system of claim 15, wherein said system comprises code adapted to perform a method for performing content search and augmented reality in a communication system comprising an Internet network attached to a mobile network, the method comprising:
a. select a plurality of content from a ranked content database that have corresponding ranking information to said searchable content; and
b. identify the closest content from the plurality of ranked content as a matching with said searchable content.
c. suggest content from said content database corresponding to said content for user's preferable choice consisting of: most popular content, most relevant content, most resembling content, location-based content, origin search-based content, nearby content, user's profile and activity behavior content, third-parties integration content, external link content, URL scheme content, chronologically sorted content and any combination thereof.

20. The system of claim 15, wherein said system comprises code adapted to perform a method for performing content search and augmented reality in a communication system comprising an Internet network attached to a mobile network, the method comprising:
a. populate an content database for matching with searchable content received from said device by including content from users; and
b. populate a content from a user corresponding to said searchable content.

21. The system of claim 1, wherein if only one unique match acquired, said user is not presented with results but said matching to unique result content is downloaded automatically.
